(19) United States
(12) Patent Application Publication
(10) Pub. No.: US 2003/0065565 A1
(43) Pub. Date: Apr. 3, 2003

(54) Method and system for routing food orders over a computer network

(76) Inventors: Peter J. Wagner, Ypsilanti, MI (US); George Z. Azrak, Ann Arbor, MI (US); Timothy J. Monteith, Ann Arbor, MI (US); James G. Vitek, Ann Arbor, MI (US); John R. Scheible, Ann Arbor, MI (US); David W. Haubenstricker, Pinckney, MI (US)

Correspondence Address: David R Syrowik, Brooks & Kushman, Twenty Second Floor, 1000 Town Center, Southfield, MI, 48075, US

(21) Appl. No.: 10/182,091

(22) PCT Filed: Jan. 26, 2001
(86) PCT No.: PCT/US01/02696

(30) Foreign Application Priority Data
Jan. 26, 2000 (US) 09491265

(51) Int. Cl. G06F 17/60

(52) U.S. Cl. 705/15

(57) ABSTRACT

An object of the present invention is to provide a method and system for routing food orders over a computer network to enable customers to place food orders such as pizza orders electronically, in a customer centric environment that reflects their needs and preferences, and provides the convenience they have come to expect from any shopping experience.

Another object of the present invention is to provide a method and system for routing food orders over a computer network wherein the invention works with point-of-sale systems such as new proposed point-of-sale systems (NGSS) and legacy point-of-sale systems (NSC, Breakaway, other) and wherein the experience of the consumer will be consistent no matter what technology exists at a food store.

### TECHNICAL FIELD

This invention relates to methods and systems for routing food orders over a computer network such as the Internet.

### BACKGROUND ART

Consumers of food such as pizza are being affected by the waves of new and innovative methods to shop for goods and services electronically. This convenience is quickly moving from a fad to a real expectation on the part of such consumers.

Telephone ordering is one method used to place take-out food orders with local restaurants. Typically, the customer attempts to locate the nearest restaurant's telephone number using a local telephone book or directory assistance. While this method is simple and easy to use, the customer is burdened with the task of identifying the appropriate restaurant location.

Other existing ordering systems utilize a call center. This method uses a one-number approach. That is, the customer calls a central location, places the order, and the call center transfers the order to the restaurant serving the customer's area. Although this system eliminates the burden on the customer in locating the nearest restaurant, the system introduces additional expenses into the restaurant operation such as the cost of maintaining and supporting the call center.

Interactive ordering systems also exist in the marketplace. These system utilize a computer controlled system that includes a database containing restaurant menu items. The interactive system permits customers to access a restaurant's menu items locally or remotely to select desired menu items for purchase. Typically, these systems require the customer to select the restaurant serving the customer's geographic region.

Order centers have been used to route pizza orders for pizza delivery. Order centers were first opened in 1983 in Virginia Beach and Salt Lake City. First Corporation order center opened in El Paso, Tex. in January 1984 using the same system as in Salt Lake City. Order routing was manual until the customer was saved in the database. A telephone number was used as the key to look up the customer's store. First Dominator Order Center opened in Ypsilanti, Mich. in April, 1985 using street files in addition to customer telephone numbers to help CSRs route orders. Customer telephone files and street files were obtained from third party vendors (i.e., Metromail, etc.) Maps of delivery areas were sent to the vendor. The Vendor then digitized the map (possibly using geo-coding technology) and provided back specific street and address ranges for each store's delivery area and a list of known telephone numbers and addresses for each delivery area. Specific steps to routing an order include:

CSR requested customer's telephone number;

Telephone number was used to look up customer record;

If customer is on file, the store number is selected from customer record and order routed;

If customer is not on file, CSR entered address, computer returned possible street list using “soundex” routine where vowels are removed, etc.;

CSR verifies spelling of street name and address, then selects correct street from list; System then provided store to route to city, state, zip, etc. for customer record;

Store receives order from call center and delivers pizza to customer.

Voice response has also been used to route calls for pizza delivery. It was first used by Rich Flory in Phoenix, Ariz. in the late 1980's. Customers called a central, local telephone number and the system prompted the customer for their telephone number and zip code. The system then returned the store's telephone number and routed the call to that store. Systems were later enhanced to use ANI and then Caller-ID to route call using database lookup base on telephone number. Market Link was also used in Minneapolis, Milwaukee, Houston, Salt Lake City, St. Louis. Market Link was eventually replaced with a US WEST system in Minneapolis and Salt Lake City. Calls not in the database were routed using zip+4.

AT&T StoreFinder has also been used to route calls for pizza delivery. It was first used in 1992 in Richmond, Va., Orlando, Fla. and Jacksonville, Fla. Different from Market Link in that that system was housed in AT&T central office and accepted calls from 950 prefixed numbers allowing a nationwide “local” number 950-1430. The call routing database was preloaded with a list of customer telephone numbers from a database provided by Metromail. AT&T was prohibited by tariff to provide the database. Maps of delivery areas were sent to Metromail (as in order centers). They built call routing database from maps, possibly using geo-coding technology. If a customer's telephone number was not listed, the call was routed to a store based on exchange prefix of the customer telephone number.

U.S. Pat. No. 4,797,818 and Re. 36,111 describe methods of mapping a customer's address to a particular operation center based on selected geographic information, including but not limited to geographic information such as address and telephone number.

U.S. Pat. No. 5,991,739 discloses a system and method for providing an online ordering machine that manages the distribution of home-delivered products over a distributed computer system. The distribution computer system includes a group of customers connected to client computers and at least one server computer system that executes the online ordering machine. The online ordering machine provides the customers with product information from various vendors whose delivery range is within the customer's location or with product information from vendors having take-out service within a specified range from the customer's location. The vendor's and customer's location is associated with a geo-code representing the latitude and longitude coordinates of the location. The search for the vendors servicing the customer's location is done using the geo-codes. The online ordering machine accepts orders from the customer for a particular product from a selected vendor. The order is converted into voice instructions which are transmitted to the vendor through a telephone call. The vendor receives the telephonic order and responds to voice-prompted instructions used to confirm the order.

### SUMMARY OF THE INVENTION

An object of the present invention is to provide a method and system for routing food orders over a computer network to enable customers to place food orders such as pizza orders electronically, in a customer centric environment that reflects their needs and preferences, and provides the convenience they have come to expect from any shopping experience.

Another object of the present invention is to provide a method and system for routing food orders over a computer network wherein the invention works with point-of-sale systems such as new proposed point-of-sale systems (NGSS) and legacy point-of-sale systems (NSC, Breakaway, other) and wherein the experience of the consumer will be consistent no matter what technology exists at a food store.

In carrying out the above objects and other objects of the present invention, a method is provided for routing food orders over a computer network. The method includes storing store data which identifies a plurality of food stores, their locations, their delivery areas and their hours of operation and receiving over the computer network delivery location data which identifies a delivery location at which ordered food is to be delivered. The method includes storing customer data which identifies customers and customer preferences. The method also includes locating a servicing food store which either delivers food to the delivery location or is located within a predetermined distance of the delivery location based on the store data and the delivery location data. The method further includes receiving a food order signal and transmitting food order data which identifies a food order based on the food order signal and the customer data together with the delivery location data over the computer network to the servicing food store and, preferably, to a point-of-sale system of the servicing food store such as new and legacy point-of-sale systems.

The method may further include transmitting delivery time data which identifies an estimated delivery time for the ordered food over the computer network.

The method may further include transmitting status data which identifies status of the food order over the computer network.

The method may further include transmitting food order change data which identifies a modification or cancellation of the food order over the computer network to the point-of-sale system of the servicing food store.

The customer preferences may include food orders and delivery locations defined by the customers.

The computer network is preferably the Internet, but may be an intranet or other private computer network.

Preferably, the store data, the delivery location data and the food order data is transmitted in an XML format via HTTP.

Also, preferably, the store data identifies information for pricing and placing a food order with each of the food stores wherein the method may further include transmitting the store data over the computer network.

Further in carrying out the above objects and other objects of the present invention, a system is provided for routing food orders over a computer network. The system includes a store memory for storing store data which identifies a plurality of food stores, their locations, their delivery areas and their hours of operation, and an input port for receiving delivery location data which identifies a delivery location at which ordered food is to be delivered and a food order signal over the computer network. The system includes a customer memory for storing customer data which identifies customers and customer preferences. The system also includes a store locator for locating a servicing food store which either delivers food to the delivery location or is located within a predetermined distance of the delivery location based on the delivery location data and the store data. The system further includes an output port for transmitting the food order data together with the delivery location data based on the food order signal and the customer data over the computer network to the servicing food store and, preferably, to a point-of-sale system of the servicing food store such as new or legacy point-of-sale systems.

The output port may transmit delivery time data which identifies an estimated delivery time for the ordered food over the computer network.

The output port may transmit status data which identifies status of the food order over the computer network.

The output port may transmit food order change data which identifies a modification or cancellation of the food order.

The customer preferences may include delivery locations and food orders defined by the customers.

Preferably, the computer network is the Internet, but may be any intranet or other private computer network.

The store data may identify information for pricing and placing a food order with each of the food stores wherein the output port transmits the store data over the computer network.

The food order signal and transmitted food order data which identifies a food order may originate from a new and legacy point-of-sale system of a food store which will not service a food order (i.e., an originating store) but which will record the food order as conveyed by the customer for transmission to the servicing food store over the computer network.

The above objects and other objects, features, and advantages of the present invention are readily apparent from the following detailed description of the best mode for carrying out the invention when taken in connection with the accompanying drawings.

### BRIEF DESCRIPTION OF DRAWINGS

FIG. 1 is a schematic diagram of the system of the present invention operating within a computer network such as the Internet; and

FIG. 2 is a generalized block diagram flow chart of one embodiment of the method of the present invention.

### BEST MODE FOR CARRYING OUT THE INVENTION

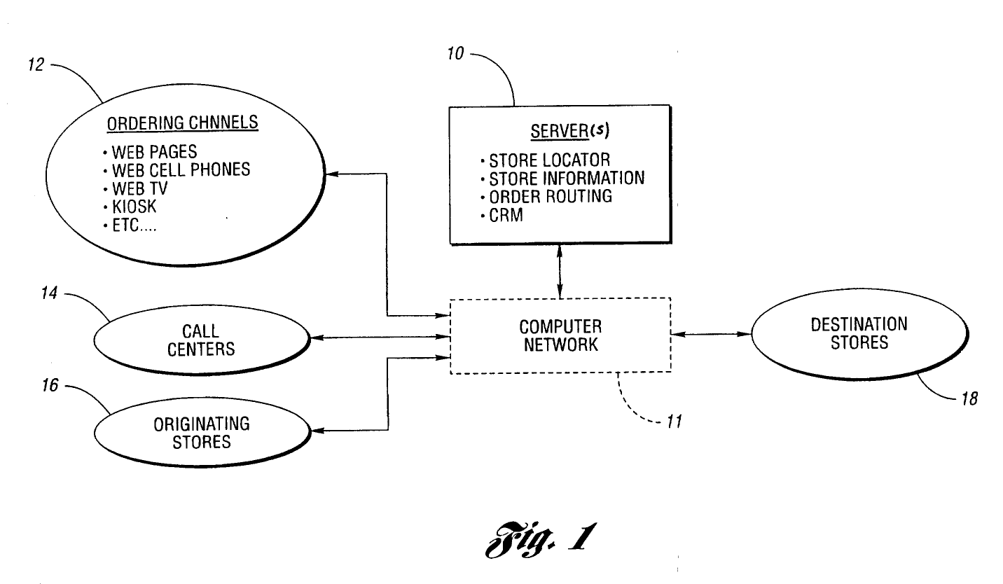

In general, a system comprising one or more or servers constructed in accordance with the present invention is generally indicated at 10 in FIG. 1. The system 10 can simply be looked at as a router of food or pizza ordering transactions over a computer network 11, such as the Internet.

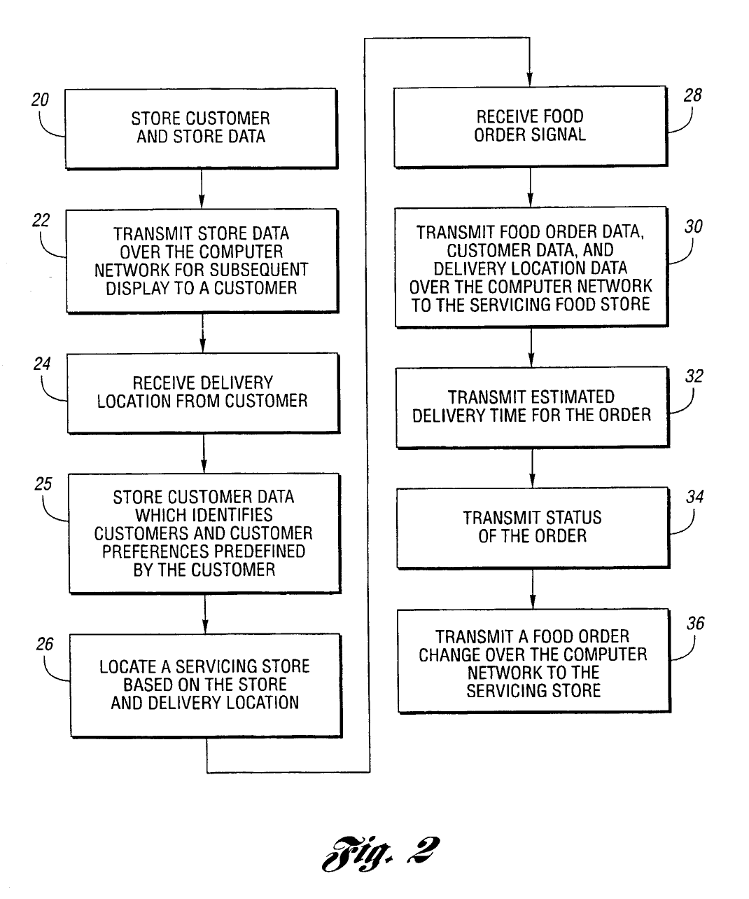

Referring now to FIGS. 1 and 2, there are illustrated a plurality of food ordering channels 12. The system 10 of the present invention, in general, can receive signals or orders as indicated at block 28 of FIG. 2 from any Internet-based front end device that captures orders for food, such as pizza. The system 10 is able to process orders coming from a variety of ordering channels 12. An order can come from a web page or any other cyber mall or ordering partner. An order can come from any wireless web device (e.g., cell phones). An order can come from devices which employ different technologies enabling consumers to order through their TVs. An order can also come from Kiosks placed at malls or other places.

The system 10 can also receive food orders from call centers 14. The system 10 is a conduit for any orders that are processed by a call center 14.

The system 10 can further receive food orders from an order-originating store 16. This feature enables consumers to call any food store and be able to place an order. The originating store 16 can have an order routed to a destination store 18 through the system 10 so that the destination store 18 can deliver the order to the customer.

Referring now specifically to the system or server 10, the system 10 includes a number of features which allow the system to perform a number of tasks as follows.

Store Locator

As indicated in FIG. 2, after receiving an address of the customer or a specified delivery location, as indicated at block 24, the system 10 locates the address, store number and phone number of the store that services the delivery location, as indicated at block 26. If no store services the delivery location, then the system 10 provides information on all stores within a predefined radius of the delivery location such as three miles.

Store Information

As indicated at block 20 of FIG. 2, the system stores all information needed by an ordering partner to price and place an order. This information includes:

Store location;

Store delivery area as defined by street files and hours of operation. The delivery area can vary by the time of day and day of the week as some stores are not open for lunch and neighboring stores take on servicing these areas during lunch;

Store service methods and hours of operation (e.g., Take Out, Delivery, Drive In, Drive Thru, etc.) Store menu;

Store taxes;

Store specials and coupons;

Payment methods accepted by the store (checks, types of credit or debit cards, dormitory meal cards, etc.);

Possible methods for reaching the store to place orders (fax, IVR, etc.).

A cyber or ordering partner could decide to have this data transmitted to their servers from the system 10, as indicated at block 22, in order to be able to present this information to the consumer in a timely manner.

Order Routing

The system 10 places or transmits the order at a destination or servicing store directly into its point-of-sale system, as indicated at block 30 of FIG. 2. It alerts the store employees of the new order and returns to the cyber or ordering partner the estimated delivery time for that order, as indicated at block 32. Cyber or ordering partners can inquire as to the status of the order (in the oven, on the way, etc.), as indicated at block 34. Cyber partners can modify or cancel the order under certain circumstances, as indicated at block 36.

In case the order cannot be placed at the store, the system 10 goes through an escalation procedure that could use fax, IVR, and a call center to make sure the order is placed at the store. If all escalation fails, the originating cyber partner is alerted.

CRM (Customer Relationship Management)

The system 10 stores records of customers and the information necessary to interact with them properly such as customer preferences, as also indicated at block 20 of FIG. 2. This set of information is referred to as “CRM customer bundle.” This customer bundle contains the following elements:

Customer ID.

Customer possible phone numbers.

Customer delivery locations. The customer is able to set these locations and name them (e.g., home, work, in-laws, babysitter, etc.) and refer to them in the ordering process by name. These locations can be set through a website or by having the CSR ask the customer if they want the system 10 to remember these locations.

Customer food preferences (e.g., light cheese, cook the wings well, vegetarian, etc.).

Customer predefined orders. Each customer can predefine orders and name them and refer to them by name (e.g., kids order, family order, work order, party order, etc.). These orders can be preset through a website or by asking the customer if they want the system to remember that order and name it for future reference.

Customer payment methods. The system 10 stores and names the credit card, debit card or any other payment method the customer wants the system 10 to remember. This information can be set on a website or by the CSR at the request of the customer.

On account information. The system 10 maintains accounts for types of customers (schools, businesses) where it is allowed.

Customer Behavior Segment. These are recency/frequency/monetary, product affinity, customer segmentation, etc. These fields are processed in a data warehouse and transferred to the system 10 on a periodic basis.

Order history. In summary form or in detail form (for each transaction).

This CRM information can be provided to cyber channels as it is appropriate. Cyber channels can request subsets of this information based on the ordering environment. This is done through an XML-based API.

APIs

Information stored or routed through the system 10 preferably uses XML-based APIs wrapped in a transport layer.

While the best mode for carrying out the invention has been described in detail, those familiar with the art to which this invention relates will recognize various alternative designs and embodiments for practicing the invention as defined by the following claims.

What is claimed is:

1. A method for routing food orders over a computer network, the method comprising:
storing store data which identifies a plurality of food stores, their locations, their delivery areas and their hours of operation;
receiving over the computer network delivery location data which identifies a delivery location at which ordered food is to be delivered;
storing customer data which identifies customers and customer preferences;
locating a servicing food store which either delivers food to the delivery location or is located within a predetermined distance of the delivery location based on the store data and the delivery location data; and
receiving a food order signal and transmitting food order data which identifies a food order based on the food order signal and the customer data together with the delivery location data over the computer network to the servicing food store.

2. The method as claimed in claim 1 wherein the servicing food store has a point-of-sale system and wherein the food order data, the customer data and the delivery location data are transmitted to the point-of-sale system.

3. The method as claimed in claim 1 further comprising transmitting delivery time data which identifies an estimated delivery time for the ordered food over the computer network.

4. The method as claimed in claim 1 further comprising transmitting status data which identifies status of the food order over the computer network.

5. The method as claimed in claim 2 further comprising transmitting food order change data which identifies a modification or cancellation of the food order over the computer network to the point-of-sale system of the servicing food store.

6. The method as claimed in claim 1 wherein the customer preferences include food orders and delivery locations defined by the customers.

7. The method as claimed in claim 1 wherein the computer network is the Internet, or an intranet or other private computer network.

8. The method as claimed in claim 7 wherein the store data is transmitted in XML format.

9. The method as claimed in claim 7 wherein the delivery location data is transmitted in XML format.

10. The method as claimed in claim 7 wherein the food order data is transmitted in XML format.

11. The method as claimed in claim 1 wherein the store data also identifies information for pricing and placing a food order with each of the food stores and wherein the method further comprises transmitting the store data over the computer network.

12. A system for routing food orders over a computer network, the system comprising:
a store memory for storing store data which identifies a plurality of food stores, their locations, their delivery areas and their hours of operation;
an input port for receiving delivery location data, which identifies a delivery location at which ordered food is to be delivered, and a food order signal over the computer network;
a customer memory for storing customer data which identifies customers and customer preferences;
a store locator for locating a servicing food store which either delivers food to the delivery location or is located within a predetermined distance of the delivery location based on the delivery location data and the store data; and
an output port for transmitting the food order data together with the delivery location data based on the food order signal and the customer data over the computer network to the servicing food store.

13. The system as claimed in claim 12 wherein the servicing food store has a point-of-sale system and wherein the food order data, the customer data and the delivery location data are transmitted to the point-of-sale system.

14. The system as claimed in claim 12 wherein the output port transmits delivery time data which identifies an estimated delivery time for the ordered food over the computer network.

15. The system as claimed in claim 12 wherein the output port transmits status data which identifies status of the food order over the computer network.

16. The system as claimed in claim 12 wherein the output port transmits food order change data which identifies a modification or cancellation of the food order.

17. The system as claimed in claim 12 wherein the customer preferences include food orders and delivery locations defined by the customers.

18. The system as claimed in claim 12 wherein the computer network is the Internet, or an intranet or other private computer network.

19. The system as claimed in claim 18 wherein the store data is transmitted in XML format.

20. The system as claimed in claim 18 wherein the delivery location data is transmitted in XML format.

21. The system as claimed in claim 18 wherein food order data is transmitted in XML format.

22. The system as claimed in claim 12 wherein the store data also identifies information for pricing and placing a food order with each of the food stores and wherein the output port transmits the store data over the computer network.
